(19) United States
(12) Patent Application Publication
(10) Pub. No.: US 2026/0369178 A1
(43) Pub. Date: Nov. 19, 2026

(54) DEVICE FOR SENSORY ENHANCEMENT OF MOTION-ORIENTED SIMULATIONS

(71) Applicant: Timothy Freriks, Old Hickory, TN (US)

(72) Inventor: Timothy Freriks, Old Hickory, TN (US)

(21) Appl. No.: 19/570,958

(22) Filed: Mar. 18, 2026

Related U.S. Application Data
(60) Provisional application No. 63/806,351, filed on May 15, 2025.

(51) Int. Cl. G09B 9/12; G09B 9/05

(52) U.S. Cl. CPC G09B 9/12; G09B 9/05

(57) ABSTRACT

A seat-mountable motion simulation device that provides physical motion feedback to users of vehicle simulation programs, including flight simulators, racing simulators, and similar programs. The device comprises a lower platform, an upper platform upon which a user sits, a plurality of motion devices disposed between the platforms, an onboard microprocessor, and a rechargeable power source. The microprocessor receives motion data from a simulation program via USB or Wi-Fi and instructs the motion devices to move the upper platform in correspondence with the simulated vehicle's movements, including pitch, roll, yaw, acceleration, deceleration, and turbulence. The device is sized to rest on any conventional seat or chair without modification that provides provides an affordable, portable alternative to full-motion simulation platforms.

### CROSS-REFERENCE TO RELATED APPLICATION

This application claims the benefit of U.S. Provisional Patent Application Ser. No. 63/806,351, filed May 15, 2025, titled “Device to Enhance the Sensory Feeling of Flying in a Flight Simulator,” the entire disclosure of which is incorporated herein by reference.

### FIELD OF THE INVENTION

The present disclosure relates generally to motion simulation devices, and more particularly to a portable seat-mounted device that provides sensory motion feedback to users of computer-based vehicle simulators, including but not limited to flight simulators, racing simulators, and other motion-oriented simulation programs.

### BACKGROUND OF THE INVENTION

Computer-based vehicle simulators—including flight simulators, racing simulators, and analogous simulation programs—present graphical depictions of vehicle motion, including lateral movement, rotational movement, vertical movement, acceleration, deceleration, and combinations thereof, through a monitor or other display device. A user (also referred to herein as a “gamer”) interacting with such a simulator observes these movements visually but, in most conventional setups, does not experience a corresponding physical or vestibular sensation.

The correspondence between visual stimuli and physical sensation plays a significant role in effective simulation training. Pilots and other vehicle operators who train using simulators benefit from experiences that closely approximate real-world sensory conditions. Without synchronized physical motion, the training value of the simulation is reduced because the trainee cannot develop the internal proprioceptive and vestibular associations that accompany actual flight or vehicle operation. Similarly, for non-training or recreational use of simulators, the absence of motion feedback reduces immersion and enjoyment.

Full-motion simulation platforms exist that address this need by physically moving an entire cockpit or cabin structure in response to simulated vehicle data. However, such systems are prohibitively expensive for individual consumers and for many training organizations. As a result, the vast majority of simulation users have no access to motion feedback of any kind.

Prior art devices have attempted to provide vestibular feedback in gaming contexts. For example, U.S. Pat. No. 8,150,480 (Johansson) and U.S. Patent Application Publication No. US 2023/0231458 A1 (Gagnon) describe systems that provide motion input to users in entertainment settings such as home use or movie theaters. These prior art systems are primarily designed for entertainment rather than simulation training, and the prior art devices generally sit beneath a separate chair or seat rather than being placed directly upon an existing seat. These devices also do not contemplate the full range of motion inputs—including pitch, roll, yaw, acceleration, deceleration, and turbulence simulation—that are desirable in a simulation training context.

Accordingly, there exists a need in the art for a compact, portable, affordable motion-feedback device that can be placed atop an existing seat or chair, that interfaces directly with simulation software via USB or wireless communication, and that provides a meaningful range of motion feedback corresponding to the full range of movements displayable by modern simulation software.

### SUMMARY OF THE INVENTION

In one aspect, the present invention provides a seat-mounted motion simulation device comprising an upper platform, a lower platform, a plurality of motion devices positioned between the upper platform and the lower platform, an onboard microprocessor communicably coupled to the plurality of motion devices, and a power source. The microprocessor receives motion data from simulation software and instructs the motion devices to move the upper platform in a manner corresponding to the motion data.

In another aspect, the device is configured to receive motion data from a simulation program via a USB connection, a Wi-Fi connection, or both.

In another aspect, the motion devices are configured to impart to the upper platform at least two of the following movements: a forward tilt corresponding to a simulated climb; a rearward tilt corresponding to a simulated descent; a left tilt corresponding to a simulated right bank or right turn; a right tilt corresponding to a simulated left bank or left turn; a lateral translation corresponding to simulated drift or sliding; a rotational displacement corresponding to simulated yaw or spin; and irregular multi-axis movements corresponding to simulated turbulence or road irregularities. For deceleration, the top platform is moved forward to induce the feeling of having the vehicle decelerate. For acceleration, the top platform is moved backward to induce the feeling of having the vehicle accelerate.

In another aspect, the device is sized and configured to be placed upon a wide variety of existing chairs or seats commonly used by gamers and simulation operators, without requiring modification to the chair or the simulation system.

The foregoing summary is illustrative only and is not intended to be limiting. Additional features and advantages of the invention will be apparent from the detailed description that follows.

### BRIEF DESCRIPTION OF THE DRAWINGS

The accompanying drawings, which are incorporated in and constitute a part of this specification, illustrate embodiments of the invention and together with the description serve to explain the principles of the invention.

FIG. 1 is a perspective view illustrating a user seated in a chair and operating a simulation device, with the invention positioned between the user and the chair;

FIG. 2 is an exploded perspective view illustrating the components of one embodiment of the device, including the cushion (201), the upper and lower platforms (202), the spring or cushioning elements (203a, 203b), the microprocessor (204), the transfer rods (205), the power source (206), and the vertical and horizontal motion devices (207, 208);

FIG. 3 is a schematic diagram illustrating the flow of data and electrical power through the device, including the receipt of motion telemetry from the simulator to the microprocessor via USB or Wi-Fi, simulator, the microprocessor (302), the USB connection (304a), the Wi-Fi receiver (303) and Wi-Fi connection (304b), the USB port (309), the wiring (306), and the motion devices (301) as arranged in the device;

FIG. 4 is a top plan view illustrating the activation patterns of vertical motion devices (S1, S2, S3, S4) for a representative set of simulated maneuvers, including right bank (402), left bank (403), climb (404), and descent (405); and

FIG. 5 is a top plan view illustrating the activation patterns of vertical motion devices (S1, S2, S3, S4) and horizontal motion devices (S5, S6) for simulated yaw, rotation, and combined maneuvers, including right rotation (504) and left rotation (505) of the upper platform.

### DETAILED DESCRIPTION OF THE INVENTION

Reference will now be made in detail to the presently preferred embodiments of the invention, examples of which are illustrated in the accompanying drawings. Wherever possible, the same reference numbers will be used throughout the drawings to refer to the same or like parts. It will be understood that the described embodiments are illustrative, and that the scope of the invention is not limited to the particular embodiments described.

### I. Overview and General Configuration

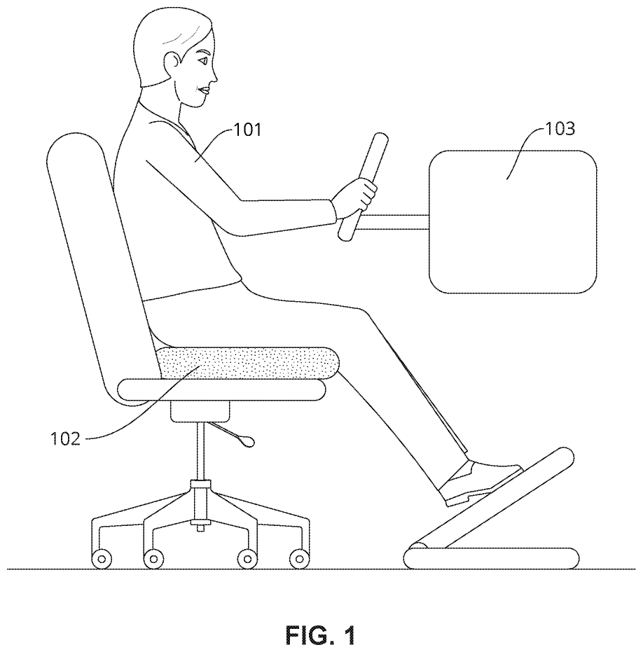

Referring to FIG. 1, the device (102) is designed to be placed upon any seat or chair that a gamer (101) would ordinarily use to operate a simulation device (103). In a preferred embodiment, the device has a footprint of approximately 14 inches by 14 inches, a size selected to accommodate the majority of chairs and seats commonly used in simulation setups. A cushion (201) may be provided on the upper surface of the upper platform to enhance user comfort. The dimensions and shape of the device may be varied to accommodate different seating arrangements.

### II. Platform and Structural Components

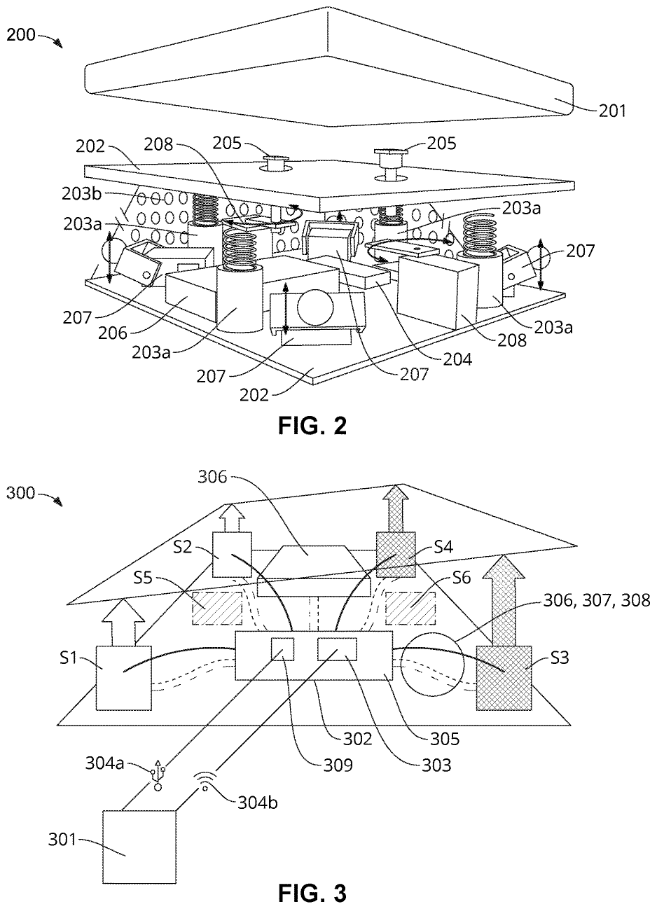

Referring to FIG. 2, the device comprises two semi-rigid platforms (202): a lower platform upon which the mechanical and electrical components are mounted, and an upper platform upon which the cushion (201) and user are supported. The platforms may be constructed from a variety of suitable materials, including but not limited to engineered plastics, composite materials, or lightweight metals. The platforms are substantially rigid but may include regions of flexibility as appropriate to accommodate desired movement.

Between the upper and lower platforms, a plurality of cushioning or spring elements (203a, 203b) may be provided to moderate platform movement, absorb shock, resist unintended displacement, and enhance user comfort. In one embodiment, spring elements (203a) are positioned at or near multiple locations of the lower platform. In an alternative embodiment, spring-like flexible panels (203b) may be provided on the perimeter of the device to provide cushioning while resisting excessive twisting or lateral displacement. Other cushioning configurations are also contemplated.

### III. Motion Devices

A plurality of motion devices is positioned between the upper and lower platforms to effect movement of the upper platform relative to the lower platform. In a preferred embodiment, vertical motion devices (207) are positioned at or near each corner of the device and are configured to extend and retract vertically to raise or lower the corresponding corner of the upper platform. In one embodiment, the vertical motion devices comprise high-torque servo motors. In alternative embodiments, the vertical motion devices may comprise stepper motors, linear actuators, hydraulic or pneumatic cylinders, or other suitable actuators capable of controlled vertical displacement. Any such device capable of raising or lowering a portion of the upper platform shall be considered within the definition of “motion device” or “lifting device” as used herein.

In addition to the vertical motion devices, one or more horizontal motion devices (208) may be positioned on opposing sides of the device to impart lateral or rotational movement to the upper platform. In a preferred embodiment, two horizontal motion devices are provided. These devices may move in the same direction to produce forward or rearward translation of the upper platform, simulating acceleration or deceleration of the simulated vehicle. Alternatively, the horizontal motion devices may move in opposing directions to produce rotational displacement of the upper platform, simulating yaw or spinning of the simulated vehicle. Force from the horizontal motion devices may be transmitted to the upper platform via transfer rods (205) or equivalent mechanical linkages.

The number, placement, and type of motion devices described herein represent a preferred embodiment and are not intended to be limiting. Other configurations of motion devices capable of producing the described range of platform movements are contemplated.

### IV. Microprocessor, Communication, and Power Systems

Referring to FIG. 3, the device includes an onboard microprocessor (302) configured to receive motion data and telemetry from simulation software and to generate control signals instructing the motion devices to move in a manner corresponding to the received data. The microprocessor may receive data via a USB connection (304a) through a USB port (309), via a Wi-Fi wireless signal received by an onboard Wi-Fi receiver (303), or via both. The microprocessor interprets motion data representing vehicle states such as pitch, roll, yaw, speed, acceleration, or sudden changes in state, such as bounces, impacts, turbulence or the like, and deceleration, and translates this data into control instructions distributed to the respective motion devices via wiring (306) or other suitable signal pathways.

Proprietary software executing on the microprocessor interprets the received simulation data and generates the appropriate control signals for each motion device. The software is designed to interface with a variety of simulation programs that are capable of outputting motion-relevant data, making the device compatible with a wide range of commercially available flight simulators, racing simulators, and analogous programs.

The device is powered by an onboard rechargeable battery (206), which in a preferred embodiment comprises a 12-volt rechargeable battery. The battery provides electrical power to the motion devices and also provides a 5-volt regulated output to power the microprocessor. The device includes an on/off switch and may include a battery charge indicator or other status indicators. Alternative power configurations, including power supplied via an external power adapter, are also contemplated.

### V. Motion Patterns—Vertical Motion Devices

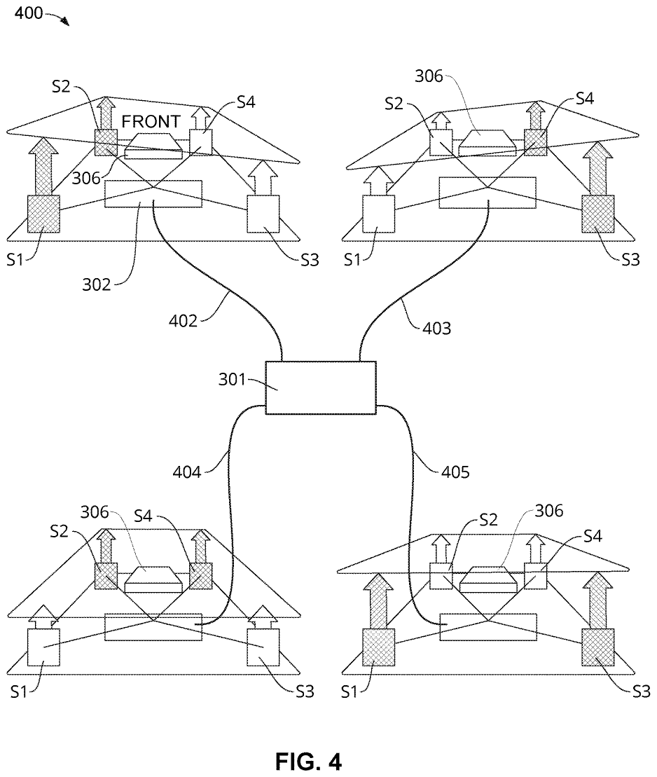

Referring to FIG. 4, in a preferred embodiment, the device includes four vertical motion devices labeled S1, S2, S3, and S4, positioned at or near the four corners of the device. S1 and S3 are positioned on one lateral side (e.g., the left side), and S2 and S4 are positioned on the opposing lateral side (e.g., the right side). S1 and S2 are positioned toward the front of the device, and S3 and S4 are positioned toward the rear.

For a simulated right bank or right turn (402), the motion devices on the left side of the device (S1 and S3) extend upward, raising the left side of the upper platform and causing the upper platform to tilt to the right. This imparts to the seated user a physical sensation corresponding to a right-banking turn, consistent with the visual display presented by the simulation software.

For a simulated left bank or left turn (403), the motion devices on the right side of the device (S2 and S4) extend upward, raising the right side of the upper platform and causing the upper platform to tilt to the left.

For a simulated climb, ascending grade, or cresting a wave (404), the forward motion devices (S2 and S4, or alternatively S1 and S2 depending on orientation) extend upward, raising the front of the upper platform to simulate the nose-up attitude of a climbing vehicle.

For a simulated descent (405), the rear motion devices extend upward, tilting the upper platform forward to simulate a nose-down or descending attitude.

For combination maneuvers—such as a climbing right bank or a descending left bank—the appropriate combination of motion devices is activated, causing the upper platform to tilt simultaneously in multiple axes as instructed by the simulation data.

### VI. Motion Patterns—Horizontal Motion Devices and Combined Movements

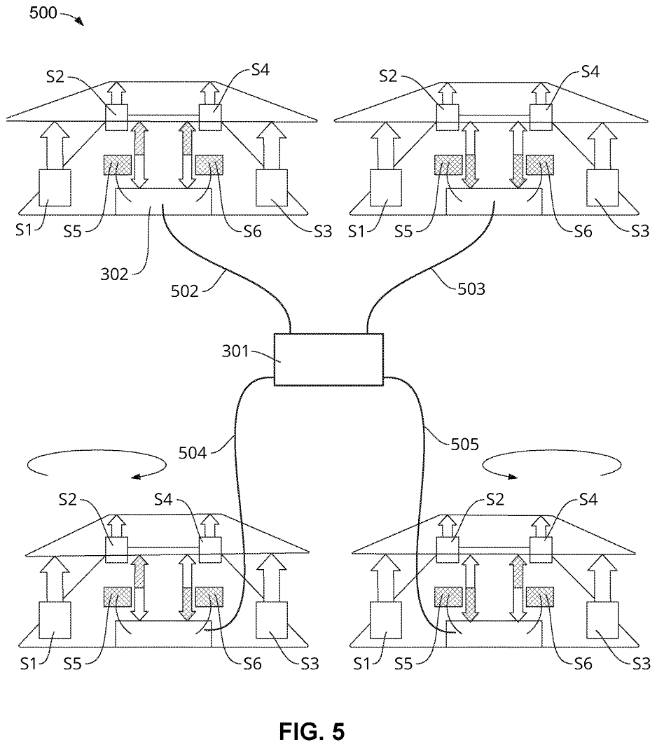

Referring to FIG. 5, the device includes two horizontal motion devices (S5 and S6) positioned on opposing sides of the device. These devices may operate in concert or in opposition to produce additional motion effects.

For simulated yaw or rotational spin (S5, S6), the two horizontal motion devices move in opposing directions, causing the upper platform to rotate clockwise (504) or counterclockwise (505) as viewed from above, consistent with yaw or spinning motion in the simulation.

For simulated acceleration (502), the horizontal motion devices move in the same direction toward the rear of the device, displacing the upper platform rearward to produce a sensation corresponding to forward acceleration. For simulated deceleration (503), the horizontal motion devices move in the same direction toward the front of the device, displacing the upper platform forward to produce a sensation corresponding to braking or deceleration.

For simulated turbulence, road irregularities, or similar chaotic motion, the motion devices are activated in a rapid, programmatically defined sequence that produces irregular multi-directional movement of the upper platform, imparting a physical sensation corresponding to the turbulence or road disturbance displayed by the simulation.

While the described motion patterns reflect a preferred embodiment for flight simulation, those of ordinary skill in the art will recognize that the device is equally applicable to racing simulators and other vehicle simulations in which the simulation program outputs motion-relevant data. The microprocessor software may be configured or updated to accommodate additional motion patterns as appropriate for different simulation applications.

### VII. Compatibility and Interoperability

The device is designed to be compatible with any simulation program that provides motion data or telemetry via USB, Wi-Fi, or other data communication protocols. The microprocessor and software are configured to interpret data in the formats output by commonly available simulation programs, and the device may be updated via software to accommodate new simulation programs or data protocols. The device does not require modification to the simulation software or the simulation hardware platform.

The device is further designed to be interoperable with any seat or chair of appropriate size and construction that a gamer or simulation operator would ordinarily use. No modification to the seat or chair is required. The device rests upon the seat and supports the user above the seat surface.

It will be apparent to those skilled in the art that various modifications and variations can be made in the present invention without departing from the spirit or scope of the invention. The invention is intended to cover all such modifications and variations as fall within the scope of the appended claims.

What is claimed is:

1. A seat-mountable motion simulation device comprising:
a lower platform;
an upper platform disposed above the lower platform, the upper platform configured to support a seated user;
a plurality of motion devices disposed between the lower platform and the upper platform, the motion devices being configured to selectively displace the upper platform relative to the lower platform in one or more axes of movement;
a microprocessor communicably coupled to the plurality of motion devices and configured to receive simulation motion data from a vehicle simulation program and to generate control signals instructing the motion devices to displace the upper platform in a manner corresponding to the simulation motion data; and
a power source configured to supply electrical power to the plurality of motion devices and to the microprocessor.

2. The device of claim 1, wherein the microprocessor is configured to receive simulation motion data or telemetry via a USB connection.

3. The device of claim 1, wherein the microprocessor is configured to receive simulation motion data via a Wi-Fi wireless connection.

4. The device of claim 1, wherein the microprocessor is configured to receive simulation motion data via both a USB connection and a Wi-Fi wireless connection.

5. The device of claim 1, wherein the plurality of motion devices comprises at least four vertical motion devices disposed at or near corners of the device, each vertical motion device configured to selectively extend and retract in a vertical direction to raise or lower a corresponding portion of the upper platform.

6. The device of claim 5, wherein the vertical motion devices comprise servo motors.

7. The device of claim 5, wherein the vertical motion devices comprise one or more of stepper motors, linear actuators, and servo motors.

8. The device of claim 5, wherein the plurality of motion devices further comprises at least two horizontal motion devices configured to displace the upper platform in a horizontal direction.

9. The device of claim 8, wherein the at least two horizontal motion devices are configured to move in a common direction to produce forward or rearward translation of the upper platform, simulating acceleration or deceleration of a simulated vehicle.

10. The device of claim 8, wherein the at least two horizontal motion devices are configured to move in opposing directions to produce rotational displacement of the upper platform, simulating yaw of a simulated vehicle.

11. The device of claim 8, further comprising one or more transfer rods mechanically coupling the horizontal motion devices to the upper platform to transmit horizontal forces from the horizontal motion devices to the upper platform.

12. The device of claim 1, further comprising one or more cushioning elements disposed between the lower platform and the upper platform, the cushioning elements configured to resist unintended displacement of the upper platform and to dampen movement.

13. The device of claim 12, wherein the one or more cushioning elements comprise springs.

14. The device of claim 1, wherein the power source comprises a rechargeable battery.

15. The device of claim 14, wherein the rechargeable battery has a nominal voltage of 12 volts and provides a 5-volt output to power the microprocessor.

16. The device of claim 1, wherein the device has a footprint configured to be placed upon a seat or chair without modification to the seat or chair.

17. A seat-mountable motion simulation device comprising:
a lower platform;
an upper platform disposed above the lower platform and configured to support a seated user, the upper platform having a footprint sized to rest upon a conventional seat or chair without modification;
a plurality of vertical motion devices disposed at or near corners of the device between the lower platform and the upper platform;
at least two horizontal motion devices disposed between the lower platform and the upper platform;
one or more cushioning elements disposed between the lower platform and the upper platform;
a microprocessor configured to receive simulation motion data from a vehicle simulation program via at least one of a USB connection and a Wi-Fi wireless connection, and to generate control signals instructing the vertical motion devices and the horizontal motion devices to move in a manner corresponding to the simulation motion data; and
a rechargeable battery configured to supply electrical power to the motion devices and the microprocessor.
